(19) United States
(12) Patent Application Publication
(10) Pub. No.: US 2026/0100132 A1
(43) Pub. Date: Apr. 9, 2026

(54) NAVIGATION ASSISTANCE DEVICE, NAVIGATION ASSISTANCE METHOD, AND NON-TRANSITORY COMPUTER-READABLE RECORDING MEDIUM

(71) Applicant: Furuno Electric Co., Ltd., Nishinomiya-City (JP)

(72) Inventor: Kazuya NAKAGAWA, Amagasaki (JP)

(73) Assignee: Furuno Electric Co., Ltd., Nishinomiya-City (JP)

(21) Appl. No.: 19/417,385

(22) Filed: Dec. 12, 2025

Related U.S. Application Data
(63) Continuation of application No. PCT/JP2024/018750, filed on May 21, 2024.

(30) Foreign Application Priority Data
Jun. 21, 2023 (JP) 2023-101757

(51) Int. Cl. G08G 3/02; B63B 43/18; B63B 49/00; G01C 21/20

(52) U.S. Cl. CPC G08G 3/02; B63B 43/18; B63B 49/00; G01C 21/203

(57) ABSTRACT

A navigation assistance device including processing circuitry configured to: acquire first ship data including a position and a speed of a first ship; acquire second ship data including a position and a speed of a second ship; identify a risk area where a risk of the first ship and the second ship approaching each other is equal to or greater than a particular value; calculate an arrival time until the first ship arrives at the risk area; and display the risk area and display the arrival time in association with the risk area.

### CROSS-REFERENCE TO RELATED APPLICATIONS

The present application is a continuation of PCT/JP2024/018750, filed on May 21, 2024, and is related to and claims priority from Japanese patent application no. 2023-101757, filed on Jun. 21, 2023. The entire contents of the aforementioned applications are hereby incorporated by reference herein.

### BACKGROUND

### Technical Field

The disclosure relates to a navigation assistance device, a navigation assistance method, and a program.

### Conventional Art

Patent Literature 1 (Japanese Patent Application Laid-Open No. 2021-160550) discloses a give-way course search device for performing course search in the case where there is a predicted give-way area on a straight line connecting a destination and an own ship.

Conventionally, a collision risk area such as an OZT (Obstacle Zone by Target) is sometimes displayed to visualize risks around a ship. However, even if a user can learn about the spatial distribution of risks, it is still difficult to accurately know the temporal margin until the risks.

### SUMMARY

A navigation assistance device according to an aspect of the disclosure includes a first acquiring unit, a second acquiring unit, an identifying unit, a calculating unit, and a display unit. The first acquiring unit is configured to acquire first ship data including a position and a speed of a first ship. The second acquiring unit is configured to acquire second ship data including a position and a speed of a second ship. The identifying unit is configured to identify a risk area where a risk of the first ship and the second ship approaching each other is equal to or greater than a particular value. The calculating unit is configured to calculate an arrival time until the first ship arrives at the risk area. The display unit is configured to display the risk area and display the arrival time in association with the risk area. Accordingly, it becomes possible to prompt a time until a risk to a user in an easily understandable manner.

In the above aspect, the calculating unit may be further configured to calculate the arrival time to a point in the risk area that is closest to the first ship. Accordingly, it becomes possible to calculate the arrival time to the point closest to the first ship.

In the above aspect, the calculating unit may be further configured to calculate the arrival time to a point in the risk area that is located on a bow direction of the first ship. Accordingly, it becomes possible to calculate the arrival time to the point on the bow direction of the first ship.

In the above aspect, the navigation assistance device may further include a determining unit configured to determine an encountering relationship between the first ship and the second ship. The calculating unit may be further configured to determine a point for calculating the arrival time in the risk area according to the encountering relationship. Accordingly, it becomes possible to determine the point for calculating the arrival time according to the encountering relationship.

In the above aspect, the display unit may be further configured to display a type of the arrival time in the risk area. Accordingly, it becomes possible to display the type of the arrival time.

In the above aspect, the navigation assistance device may further include a determining unit configured to determine whether the risk area is included in a particular range defined based on the first ship. The calculating unit may be further configured to calculate the arrival time to the risk area included in the particular range. Accordingly, it becomes possible to calculate the arrival time to the risk area included in the particular range.

In the above aspect, the particular range may be a range where a distance from the first ship or the arrival time of the first ship is equal to or less than a particular value. Accordingly, it becomes possible to calculate the arrival time to the risk area included in a range equal to or less than a particular distance.

In the above aspect, the particular range may be a particular angle range including a bow direction of the first ship. Accordingly, it becomes possible to calculate the arrival time to the risk area included in the particular angle range.

In the above aspect, the calculating unit may be further configured to calculate the arrival time to a portion of the risk area that is included in the particular range. Accordingly, it becomes possible to calculate the arrival time to the portion included in the particular range.

In the above aspect, the navigation assistance device may further include a route acquiring unit configured to acquire a scheduled route of the first ship. The calculating unit may be further configured to calculate the arrival time for the first ship to navigate the scheduled route and arrive at the risk area. Accordingly, it becomes possible to calculate the arrival time for navigating the scheduled route and arriving at the risk area.

In the above aspect, the calculating unit may be further configured to calculate the arrival time to a point in the risk area that is located on the scheduled route. Accordingly, it becomes possible to calculate the arrival time to the point on the scheduled route.

In the above aspect, the identifying unit may be further configured to identify, as the risk area, an interval of a predicted route of the second ship where a risk of the first ship and the second ship approaching each other is equal to or greater than a particular value, with the first ship changing course and navigating in any direction to cross the predicted route of the second ship. Accordingly, it becomes possible to identify the risk area on the predicted route of the second ship.

In addition, a navigation assistance method according to another aspect of the disclosure includes: acquiring first ship data including a position and a speed of a first ship; acquiring second ship data including a position and a speed of a second ship; identifying a risk area where a risk of the first ship and the second ship approaching each other is equal to or greater than a particular value; calculating an arrival time until the first ship arrives at the risk area; and displaying the risk area and displaying the arrival time in association with the risk area. Accordingly, it becomes possible to prompt a time to a risk to a user in an easily understandable manner.

In addition, a program according to another aspect of the disclosure causes a computer to execute processing configured to: acquire first ship data including a position and a speed of a first ship; acquire second ship data including a position and a speed of a second ship; identify a risk area where a risk of the first ship and the second ship approaching each other is equal to or greater than a particular value; calculate an arrival time until the first ship arrives at the risk area; and display the risk area and display the arrival time in association with the risk area. Accordingly, it becomes possible to prompt a time to a risk to a user in an easily understandable manner.

### BRIEF DESCRIPTION OF THE DRAWINGS

FIG. 1 is a view showing an example of an onboard system.

FIG. 2 is a view showing an example of a navigation assistance device.

FIG. 3 is a view showing an example of an other ship management database.

FIG. 4 is a view showing an example of identifying a risk interval.

FIG. 5 is a view illustrating calculation of an arrival time.

FIG. 6 is a view illustrating calculation of the arrival time.

FIG. 7 is a view illustrating calculation of the arrival time.

FIG. 8 is a view illustrating calculation of the arrival time.

FIG. 9 is a view showing a display example.

FIG. 10 is a view showing a display example.

FIG. 11 is a view showing an example of identifying a risk interval.

FIG. 12 is a view showing an example of a navigation assistance method.

FIG. 13 is a view illustrating calculation of the arrival time.

FIG. 14 is a view illustrating calculation of the arrival time.

FIG. 15 is a view showing a display example.

FIG. 16 is a view showing a display example.

FIG. 17 is a view showing a display example.

### DESCRIPTION OF THE EMBODIMENTS

Embodiments of the disclosure provide a navigation assistance device, a navigation assistance method, and a program capable of prompting a time until a risk to a user in an easily understandable manner.

Hereinafter, embodiments of the disclosure will be described with reference to the drawings. In this specification and each drawing, elements similar to those described with respect to previously shown drawings will be labeled with the same reference signs, and detailed descriptions thereof may be appropriately omitted.

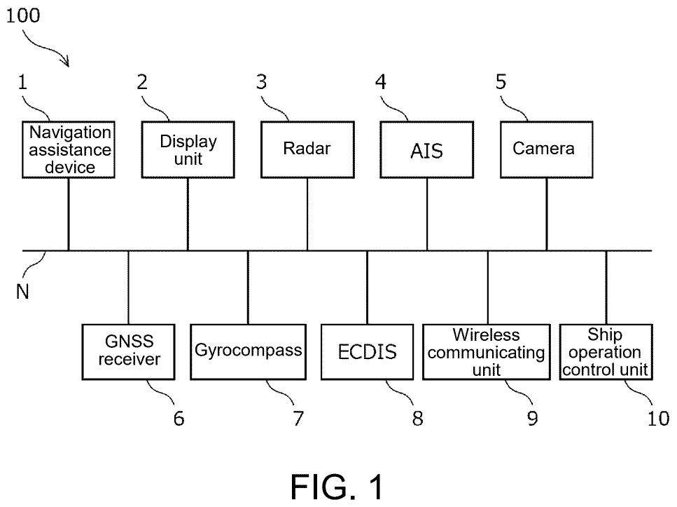

FIG. 1 is a block diagram showing a configuration example of an onboard system 100. The onboard system 100 is a system mounted on a ship. In the following description, a ship on which the onboard system 100 is mounted will be referred to as an “own ship”, and other ships will be referred to as “other ships”.

The onboard system 100 includes a navigation assistance device 1, a display unit 2, a radar 3, an AIS 4, a camera 5, a GNSS receiver 6, a gyrocompass 7, an ECDIS 8, a wireless communicating unit 9, and a ship operation control unit 10. These devices are connected to a network N such as a LAN, and are capable of performing network communication with each other.

The navigation assistance device 1 includes a computer that includes a CPU, a RAM, a ROM, a non-volatile memory, and an input and output interface. The CPU of the navigation assistance device 1 executes information processing according to programs loaded from the ROM or the non-volatile memory into the RAM.

The programs may be supplied via an information storage medium such as an optical disc or a memory card, or may be supplied via a communication network such as the Internet or the LAN.

The display unit 2 displays display images generated by the navigation assistance device 1. The display unit 2 also displays radar images, camera images, or electronic charts.

The display unit 2 is, for example, a display device with a touch sensor, i.e., a so-called touch panel. The touch sensor detects indication positions within a screen indicated by a user's finger or the like. Not limited thereto, the indication positions may also be inputted by a pointing device such as a trackball.

The radar 3 transmits radio waves around the own ship and receives reflected waves thereof, and generates echo data based on the received signals. In addition, the radar 3 identifies a target from the echo data and generates TT (target tracking) data representing the position and the speed of the target.

The AIS (Automatic Identification System) 4 receives AIS data from other ships present around the own ship or from onshore control stations. Not limited to the AIS, a VDES (VHF Data Exchange System) may also be used. The AIS data includes identification codes, ship names, positions, ship courses, ship speeds, ship types, hull lengths, and destinations of other ships.

The camera 5 is a digital camera that captures images of outside from the own ship and generates image data. The camera 5 is installed, for example, on the bridge of the own ship and oriented toward the heading. The camera 5 is, for example, a so-called PTZ camera with a pan-tilt function and an optical zoom function.

The camera 5 may include an image recognizing unit that estimates an in-image position and a type of a target such as a ship included in the captured image according to an object detection model. Not limited to the camera 5, the image recognizing unit may also be realized in other devices such as the navigation assistance device 1.

The GNSS receiver 6 detects the position of the own ship based on radio waves received from the GNSS (Global Navigation Satellite System). The gyrocompass 7 detects the heading of the own ship. Not limited to the gyrocompass, a GPS compass may also be used.

The ECDIS (Electronic Chart Display and Information System) 8 acquires the position of the own ship from the GNSS receiver 6 and displays the position of the own ship on an electronic chart. In addition, the ECDIS 8 also displays a planned route of the own ship on the electronic chart. Not limited to the ECDIS, a GNSS plotter may also be used.

The wireless communicating unit 9 includes wireless equipment that realizes satellite communication. In addition, the wireless communicating unit 9 includes wireless equipment that realizes wireless communication using, for example, ultra high frequency, very high frequency, high frequency, medium-high frequency, or medium frequency.

The ship operation control unit 10 is a control device for realizing autonomous navigation and controls the steering gear of the own ship. In addition, the ship operation control unit 10 may also control the engine of the own ship.

In this embodiment, the navigation assistance device 1 and the display unit 2 are devices independent from each other. However, not limited thereto, the navigation assistance device 1 and the display unit 2 may also be an integrated device.

In addition, the navigation assistance device 1 is an independent device, but is not limited thereto and may also be integrated with other devices such as the ECDIS 8. In other words, a part or all of the functions of the navigation assistance device 1 may also be realized in other devices.

In addition, the display unit 2 is also an independent device. However, not limited thereto, a display unit of other devices such as the ECDIS 8 may also be used as the display unit 2 that displays display images generated by the navigation assistance device 1.

In this embodiment, the navigation assistance device 1 is mounted on a ship, but is not limited thereto and may also be, for example, installed in onshore control stations and used for navigation assistance of ships under surveillance.

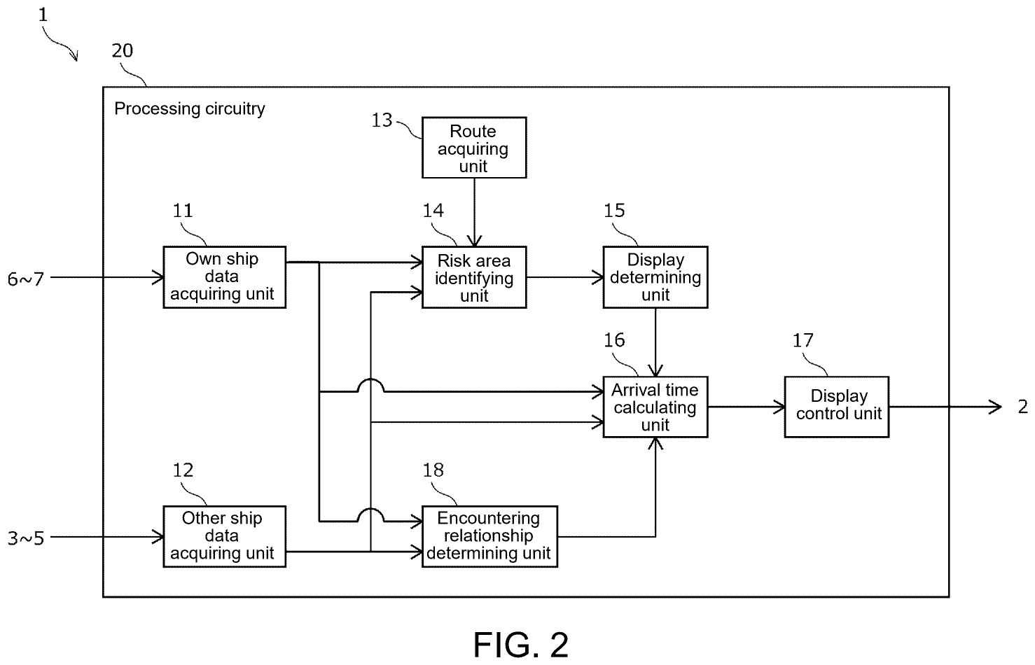

FIG. 2 is a block diagram showing a configuration example of the navigation assistance device 1. The navigation assistance device 1 includes processing circuitry 20. The processing circuitry 20 is a computer including a CPU, a RAM, a ROM, a non-volatile memory, and an input and output interface.

The processing circuitry 20 includes an own ship data acquiring unit 11, an other ship data acquiring unit 12, a route acquiring unit 13, a risk area identifying unit 14, a display determining unit 15, an arrival time calculating unit 16, a display control unit 17, and an encountering relationship determining unit 18. These functional units are realized by the CPU of the processing circuitry 20 executing information processing according to programs.

The own ship data acquiring unit 11 acquires own ship data including the position and the speed of the own ship. The own ship data acquiring unit 11 is an example of a first acquiring unit, the own ship is an example of a first ship, and the own ship data is an example of first ship data. The speed is a vector quantity represented by the ship speed and the ship course, and the ship speed is a scalar quantity.

Specifically, the own ship data acquiring unit 11 sequentially acquires the position of the own ship detected by the GNSS receiver 6, and calculates the speed of the own ship from over-time changes in the position of the own ship. Not limited thereto, the ship speed of the own ship may also be acquired from a speed log (not shown), and the ship course of the own ship may also be acquired from the gyrocompass 7.

The other ship data acquiring unit 12 acquires other ship data including the position and the speed of an other ship. The other ship data acquiring unit 12 is an example of a second acquiring unit, the other ship is an example of a second ship, and the other ship data is an example of second ship data. The other ship data is generated based on data detected by the radar 3, the AIS 4, or the camera 5 mounted on the own ship.

Specifically, the other ship data acquiring unit 12 sequentially acquires, as the other ship data, TT data generated by the radar 3, AIS data received by the AIS 4, or identification data identified from images captured by the camera 5. The other ship data acquiring unit 12 registers the acquired other ship data in an other ship management database constructed in a memory.

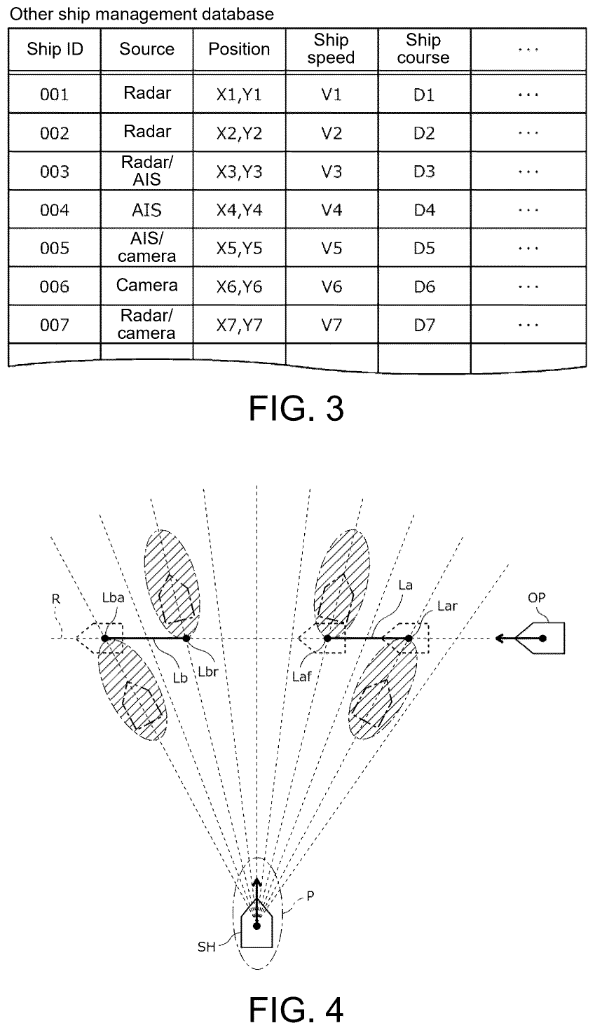

As shown in FIG. 3, the other ship management database includes fields such as “ship ID”, “source”, “position”, “ship speed”, and “ship course”. The “ship ID” is an identifier assigned to the other ship. The “source” represents by which of the radar 3, the AIS 4, and the camera 5 the other ship data has been generated.

The “position” represents the position of the other ship. The position of the other ship is represented by latitude and longitude. Since the position of the other ship detected by the radar 3 or the camera 5 is represented as a relative position with respect to the own ship, the position is converted to an absolute position using the position of the own ship detected by the GNSS receiver 6.

The “ship speed” represents the ship speed of the other ship. The “ship course” represents the ship course of the other ship. The ship speed and the ship course of the other ship detected by the radar 3 or the camera 5 are estimated from over-time changes in the in-image position of the other ship.

In the case where the position of the other ship data taking one of the AIS 3, the radar 4, and the camera 5 as the source is the same as or approximates the position of the other ship data taking another as the source, these other ship data are combined into one record as relating to a common other ship.

Returning to the description of FIG. 2, the route acquiring unit 13 acquires a scheduled route of the own ship. For example, the route acquiring unit 13 acquires the scheduled route from other devices such as the ECDIS 8. The scheduled route is a planned route to a destination based on a navigation plan. Not limited thereto, the route acquiring unit 13 may also calculate a give-way course for avoiding collision with an other ship as the scheduled route based on the own ship data and the other ship data.

The risk area identifying unit 14 identifies a risk area where a risk of the own ship and the other ship approaching each other is equal to or greater than a particular value, based on the own ship data acquired by the own ship data acquiring unit 11 and the other ship data acquired by the other ship data acquiring unit 12.

The risk area is, for example, an OZT (Obstacle Zone by Target). The display of the risk area will be described later. The risk area is not limited to an OZT, and a PAD (Predict Area of Danger) or a DAC (Dangerous Area of Collision) may also be used.

FIG. 4 is a view showing an example of identifying a risk area. The risk area identifying unit 14 identifies, as intervals for displaying a risk area, risk intervals La and Lb in a predicted route R of an other ship OP where the risk of collision or approach between the own ship SH and the other ship OP is equal to or greater than a threshold, based on the predicted positions of the own ship SH and the other ship OP at each time point when assuming that the own ship SH changes course and navigates in any direction to cross the predicted route R of the other ship OP.

The calculation of the predicted position of the own ship SH is performed on the assumption that the own ship SH changes course and navigates in any direction at the current position while maintaining the speed. That is, it is assumed that the own ship SH keeps the magnitude of the own ship speed vector constant, and the direction of the own ship speed vector changes to any direction at the reference time point, and thereafter navigation is continued from the own ship position at the reference time point in a constant direction. Thus, the predicted position of the own ship SH at each time point is present on concentric circles centered on the own ship position at the reference time point. The radius of the circle is represented by a product of an elapsed time from the reference time point and the magnitude of the own ship speed vector.

The predicted position of the own ship SH at each time point is represented by multiple concentric circles calculated for each of multiple discrete time points. Not limited thereto, the predicted position of the own ship SH at each time point may also be represented by an equation of circle that includes the elapsed time from the reference time point.

In this embodiment, the predicted position of the own ship SH is calculated on the assumption that the speed of the own ship SH is constant. However, not limited thereto, the speed of the own ship SH may also be treated as a variable that changes over time. That is, as long as the predicted position of the own ship SH corresponding to the elapsed time from the reference time point is obtained, it is also possible that the speed of the own ship SH is not constant. For example, the speed of the own ship SH may gradually increase or decrease with lapse of time.

The calculation of the predicted position of the other ship OP is performed on the assumption that the other ship OP navigates from the current position while maintaining the speed. That is, it is assumed that the magnitude and the direction of the other ship speed vector of the other ship OP are constant, and navigation is continued from the other ship position at the reference time point. Thus, the predicted position of the other ship OP at each time point is present on a straight line that passes through the other ship position at the reference time point and extends the other ship speed vector.

The predicted position of the other ship OP at each time point is represented by multiple discrete points arranged on a straight line, calculated for each of multiple discrete time points. Not limited thereto, the predicted position of the other ship OP at each time point may also be represented by a linear function that passes through the other ship position at the reference time point.

In this embodiment, the predicted position of the other ship OP is calculated on the assumption that the speed of the other ship OP is constant. However, not limited thereto, at least one of the speed and the direction of the other ship OP may also be treated as a variable that changes over time. That is, as long as the predicted position of the other ship OP corresponding to the elapsed time from the reference time point is obtained, it is also possible that the speed of the other ship OP is not constant. For example, the speed of the other ship OP may gradually increase or decrease with lapse of time. In addition, the other ship OP may change course in a particular direction, or may turn at a particular ROT (rate of turn).

The risk area identifying unit 14 calculates a separation distance between the predicted position of the own ship SH and the predicted position of the other ship OP at each time point, and calculates a risk of collision or approach based on the separation distance and the ship size. As described above, since the predicted position of the own ship SH at a particular time point is represented by a circle, from the circle representing the predicted position of the own ship SH at the particular time point, the risk area identifying unit 14 extracts the position closest to the predicted position of the other ship OP at the same time point to calculate the separation distance.

For example, in the case where the area of the own ship SH or an alert area P set around the own ship SH overlaps with a point representing the predicted position of the other ship OP, the risk area identifying unit 14 determines that the risk is equal to or greater than the threshold, and identifies multiple risk intervals La and Lb where the risk is equal to or greater than the threshold. Hereinafter, the traveling direction of the other ship OP will also be referred to as the front side, and the opposite direction will also be referred to as the rear side.

For example, of the two risk intervals La and Lb, for the first risk interval La located on the rear side, a rear end LaR of the first risk interval La becomes a position at which a front end of the alert area P of the own ship SH contacts the point representing the predicted position of the other ship OP. A front end LaF of the first risk interval La becomes a position at which a rear end of the alert area P of the own ship SH contacts the point representing the predicted position of the other ship OP.

On the other hand, of the two risk intervals La and Lb, for the second risk interval Lb located on the front side, a rear end LbR of the second risk interval Lb becomes a position at which the rear end of the alert area P of the own ship SH contacts the point representing the predicted position of the other ship OP. A front end LbF of the second risk interval Lb becomes a position at which the front end of the alert area P of the own ship SH contacts the point representing the predicted position of the other ship OP.

The range between the first risk interval La and the second risk interval Lb becomes a range where the own ship SH crosses the front side of the other ship OP. On the other hand, the range on the rear side of the first risk interval La and the range on the front side of the second risk interval Lb become ranges where the own ship SH crosses the rear side of the other ship OP. In the case where the own ship SH crosses the front side of the other ship OP, more attention is required compared to the case where the own ship SH crosses the rear side of the other ship OP.

Not limited thereto, the risk area identifying unit 14 may also determine that the risk is equal to or greater than the threshold, for example, in the case where the area of the own ship SH or the alert area P set around the own ship SH overlaps with the area of the other ship OP or an alert area set around the other ship OP. In addition, the risk area identifying unit 14 may also determine that the risk is equal to or greater than the threshold, for example, in the case where the separation distance between the point representing the predicted position of the own ship SH and the point representing the predicted position of the other ship OP is equal to or less than a threshold.

In this embodiment, the risk of collision or approach is calculated based on a distance such as the separation distance between the predicted position of the own ship SH and the predicted position of the other ship OP. However, the embodiment is not limited thereto, and the risk of collision or approach may also be calculated based on a time such as an approach time until the own ship SH and the other ship OP come closest to each other, or an arrival time until the own ship SH arrives at the predicted position of the other ship OP.

Returning to the description of FIG. 2, the display determining unit 15 determines whether the risk interval identified by the risk area identifying unit 14 is included in a particular range defined based on the own ship. The particular range is a range for determining whether to perform display of the arrival time to be described later.

The arrival time calculating unit 16 calculates an arrival time until the own ship arrives at the risk interval based on the own ship data acquired by the own ship data acquiring unit 11 and the other ship data acquired by the other ship data acquiring unit 12.

The display control unit 17 displays the risk area such as an OZT at the risk interval identified by the risk area identifying unit 14 on the image outputted to the display unit 2, and displays the arrival time calculated by the arrival time calculating unit 16 in association with the risk area.

The encountering relationship determining unit 18 determines an encountering relationship between the own ship and the other ship based on the own ship data acquired by the own ship data acquiring unit 11 and the other ship data acquired by the other ship data acquiring unit 12. Specifically, the encountering relationship determining unit 18 calculates a course difference between the own ship and the other ship, and classifies the encountering relationship according to the position of the other ship based on the own ship and the course difference. The encountering relationship includes a head-on relationship, a crossing relationship, and an overtaking relationship.

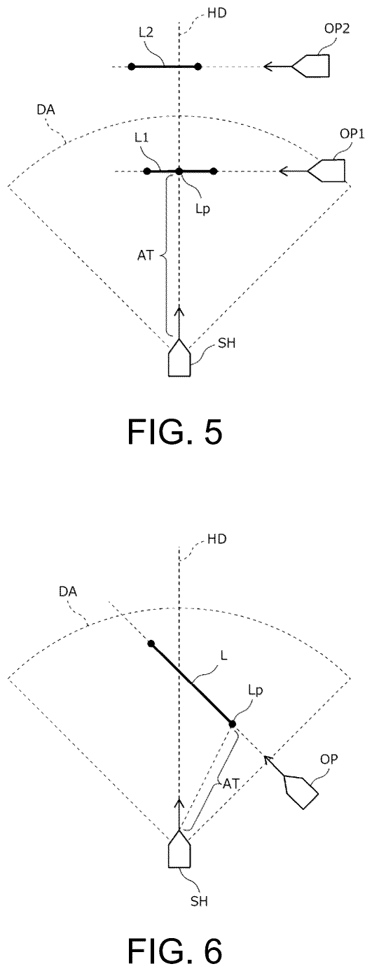

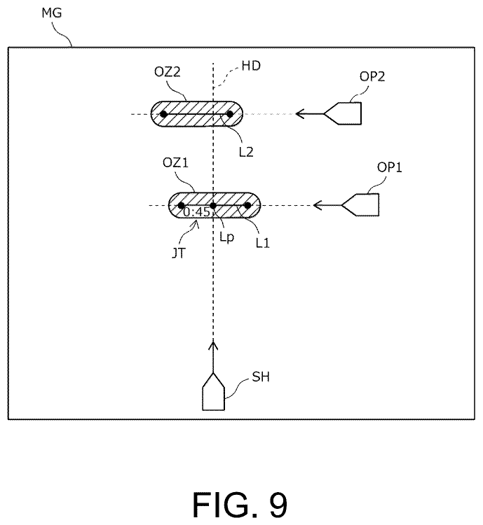

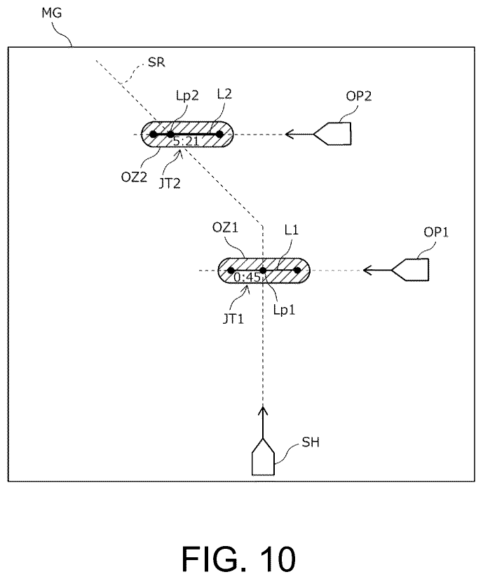

FIG. 5 to FIG. 8 are views illustrating determination of a risk interval by the display determining unit 15 and calculation of an arrival time by the arrival time calculating unit 16. FIG. 9 and FIG. 10 are views showing examples of an image MG displayed on the display unit 2 by the display control unit 17. FIG. 9 corresponds to FIG. 5, and FIG. 10 corresponds to FIG. 8.

As shown in FIG. 5, the display determining unit 15 determines whether risk intervals L1 and L2 related to other ships OP1 and OP2 are included in a particular range DA defined based on the own ship SH. In the example of the figure, the risk interval L1 is within the particular range DA, and the risk interval L2 is outside the particular range DA.

The particular range DA is, for example, a range where the distance from the own ship SH or the arrival time of the own ship SH is equal to or less than a particular value, and is a particular angle range including a bow direction HD of the own ship SH. That is, the particular range DA is a fan-shaped range centered on the bow direction HD of the own ship SH.

The particular range DA corresponds to a range that requires attention in the navigation of the own ship SH. The particular range DA may be a range where the distance from the own ship SH or the arrival time of the own ship SH is equal to or less than a particular value, or a particular angle range including the bow direction HD of the own ship SH.

The arrival time calculating unit 16 calculates the arrival time AT to the risk interval L1 included in the particular range DA. Specifically, the arrival time calculating unit 16 calculates the arrival time AT to a point Lp selected from the risk interval L1.

The point Lp for calculating the arrival time AT may be a point, in the risk interval L1, that is closest to the own ship SH, or may be a point on the bow direction HD of the own ship SH. In the example of FIG. 5, the point Lp is a point closest to the own ship SH and is also a point on the bow direction HD of the own ship SH.

The arrival time to the point on the bow direction HD of the own ship SH is a so-called BCT (Bow Crossing Time). In addition, a TCPA (Time to Closest Point of Approach) may also be used as the arrival time until the own ship SH arrives at the risk interval L1.

As shown in FIG. 6, with the other ship OP diagonally crossing the bow direction HD of the own ship SH, the point closest to the own ship SH and the point on the bow direction HD of the own ship SH may not coincide with each other. In that case, the point Lp for calculating the arrival time AT is, for example, the point closest to the own ship SH.

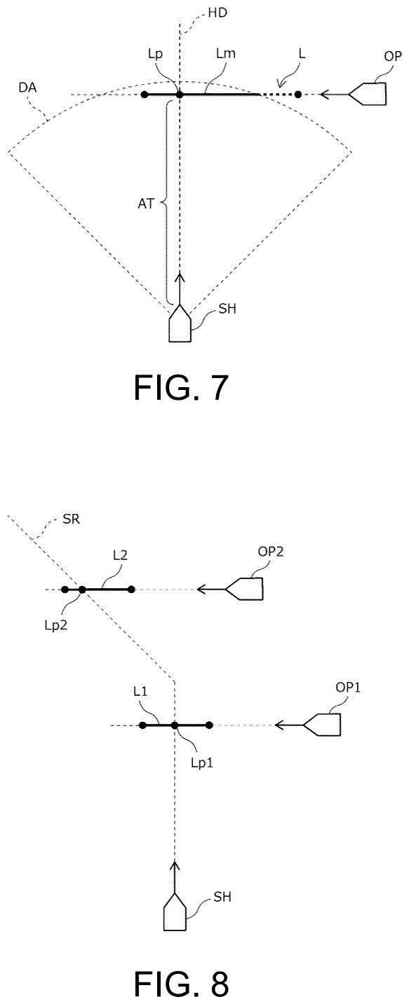

As shown in FIG. 7, there may be case where a part of a risk interval L is within the particular range DA, and the remainder is outside the particular range DA. In that case, the point Lp for calculating the arrival time AT is selected from a portion Lm of the risk interval L within the particular range DA.

As shown in FIG. 9, the display control unit 17 displays an image MG representing positional relationships of the own ship SH and other ships OP1 and OP2. In the image MG, symbols representing the own ship SH and the other ships OP1 and OP2 are placed at in-image positions corresponding to actual positions.

In addition, the display control unit 17 displays risk areas OZ1 and OZ2 at the risk intervals L1 and L2 related to the other ships OP1 and OP2. The risk areas OZ1 and OZ2 are, for example, areas of a particular width centered on the risk intervals L1 and L2.

Furthermore, the display control unit 17 displays a string JT representing the arrival time in association with the risk area OZ1 for the risk interval L1 within the particular range DA (see FIG. 5).

Specifically, the string JT representing the arrival time is displayed, for example, inside or in the vicinity of the risk area OZ1, particularly, in the vicinity of the point Lp1 with which the arrival time is calculated. Accordingly, the relationship between the string JT representing the arrival time and the risk area OZ1 is visually recognized easily.

As shown in FIG. 8, the arrival time calculating unit 16 may calculate arrival times for the own ship SH to navigate a scheduled route SR and arrive at the risk intervals L1 and L2. The arrival time calculating unit 16 calculates arrival times to points Lp1 and Lp2 of the risk intervals L1 and L2 that are located on the scheduled route SR.

As shown in FIG. 10, the display control unit 17 displays risk areas OZ1 and OZ2 at the risk intervals L1 and L2 on the scheduled route SR of the own ship SH, and displays strings JT1 and JT2 representing the arrival times in association with the risk areas OZ1 and OZ2.

As described above, since the risk interval L is calculated on the assumption that the own ship SH changes course in any direction at the current position and navigates in a straight line, in the case where the own ship SH navigates the scheduled route SR, the risk interval L may deviate from actual risk.

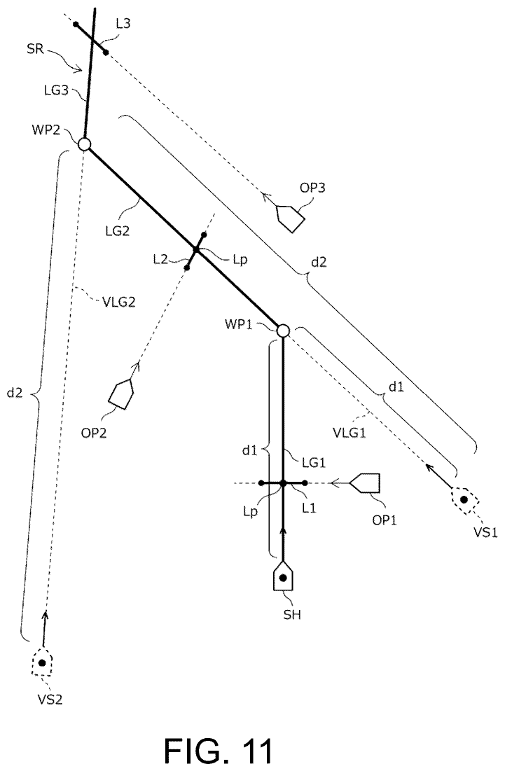

Thus, in the case where the own ship SH navigates the scheduled route SR, the risk interval L may be calculated according to a method described below as shown in FIG. 11.

The scheduled route SR includes multiple legs LG. The leg LG is a general term for a first leg LG1 to a third leg LG3. Specifically, the scheduled route SR includes the first leg LG1 from the current position of the own ship SH to a first course change point WP1, the second leg LG2 from the first course change point WP1 to a second course change point WP2, and the third leg LG3 from the second course change point WP2 to a third course change point (not shown).

The risk area identifying unit 14 sets a virtual leg VLG corresponding to each leg LG, places a virtual own ship VS on the virtual leg VLG, and calculates a risk interval L for each leg LG. The virtual leg VLG is a general term for a virtual first leg VLG1 to a virtual second leg VLG2. The virtual own ship VS is a general term for a virtual first own ship VS1 to a virtual second own ship VS2. The other ship OP is a general term for other ships OP1 to OP3. The risk interval L is a general term for risk intervals L1 to L3.

Specifically, for the first leg LG1, the risk area identifying unit 14 calculates a risk interval L with an other ship OP during a period in which the own ship SH navigates the first leg LG1, as described in FIG. 4 above. In the example of FIG. 11, the risk interval L1 of the other ship OP1 is identified in relation to the first leg LG1.

In addition, for the second leg LG2, the risk area identifying unit 14 sets the virtual first leg VLG1 extending from the first course change point WP1 in a direction opposite to the second leg LG2, and places the virtual first own ship VS1 on the virtual first leg VLG1 to calculate the risk interval L with the other ship OP during a period in which the virtual first own ship VS1 navigates the second leg LG2. In the example of FIG. 11, the risk interval L2 of the other ship OP2 is identified in relation to the second leg LG2.

The virtual first leg VLG1 is arranged in a straight line with the second leg LG2 and has a same length d1 as the length d1 of the first leg LG1. The virtual first own ship VS1 is placed at an end of the virtual first leg VLG1 opposite to the first course change point WP1.

In addition, for the third leg LG3, the risk area identifying unit 14 sets the virtual second leg VLG2 extending from the second course change point WP2 in a direction opposite to the third leg LG3, and places the virtual own ship VS2 on the virtual second leg VLG2 to calculate the risk interval L with the other ship OP during a period in which the virtual own ship VS2 navigates the third leg LG3. In the example of FIG. 11, the risk interval L3 of the other ship OP3 is identified in relation to the third leg LG3.

The virtual second leg VLG2 is arranged in a straight line with the third leg LG3 and has a same length d2 as the total length d2 of the first leg LG1 and the second leg LG2. The virtual second own ship VS2 is placed at an end of the virtual second leg VLG2 opposite to the second course change point WP2.

By performing calculation of risk intervals for all legs LG included in the scheduled route SR according to the method described above, the risk area identifying unit 14 calculates the risk intervals L in the case where the own ship SH navigates the scheduled route SR.

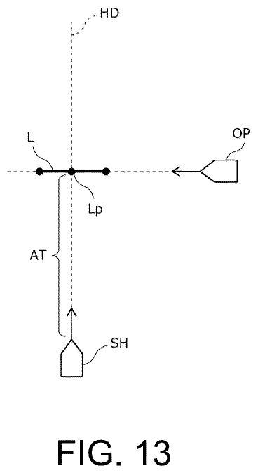

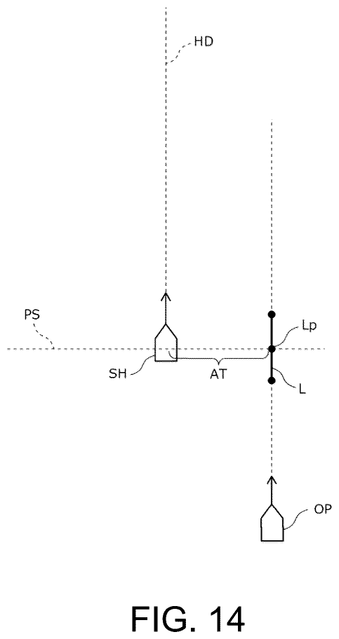

FIG. 13 and FIG. 14 are views illustrating modification examples of calculation of the arrival time. The arrival time calculating unit 16 may determine the point Lp for calculating the arrival time AT in the risk interval L according to the encountering relationship between the own ship SH and the other ship OP determined by the encountering relationship determining unit 18.

For example, as shown in FIG. 13, in the case where the other ship OP is in a crossing relationship of crossing the bow line HD of the own ship SH, the point Lp for calculating the arrival time AT is determined as a point on the bow line HD of the own ship SH in the risk interval L. That is, the arrival time AT becomes a BCT.

On the other hand, as shown in FIG. 14, in the case where the other ship OP is in an overtaking relationship of overtaking the own ship SH, the point Lp for calculating the arrival time AT is determined as a point at which the other ship OP overtakes the own ship SH. That is, it is a point at which the other ship OP passes a beam line PS of the own ship SH.

The beam line PS is a line orthogonal to the bow line HD, and is, for example, a line passing through a central position of the own ship SH. Not limited thereto, the beam line PS may also be set to pass through the bow, the stern, or the bridge of the own ship SH.

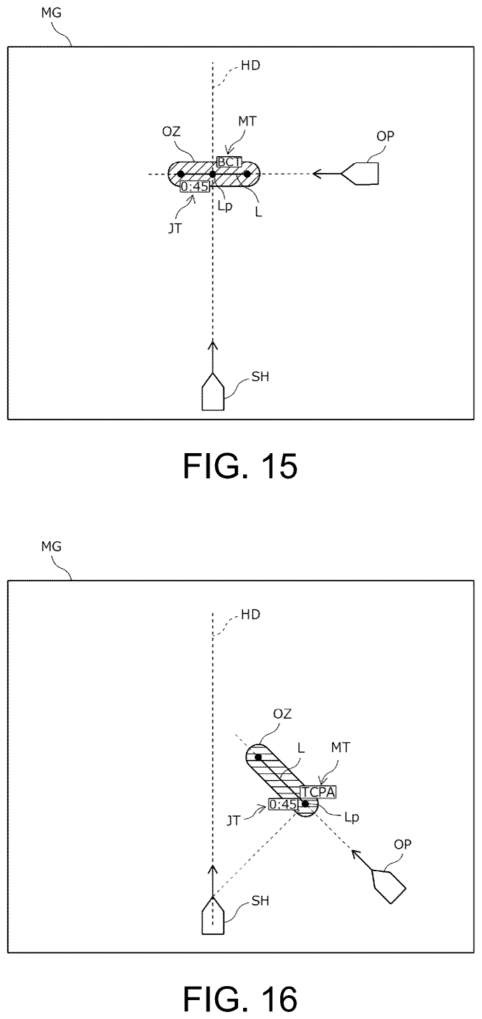

FIG. 15 to FIG. 17 are views illustrating modification examples of the image MG displayed on the display unit 2. The display control unit 17 may further display a type of the point Lp for calculating the arrival time in the risk area OZ.

Specifically, together with the string JT representing the arrival time, the display control unit 17 displays a string MT representing the type of the arrival time in association with the risk area OZ. Not limited to a string, a symbol representing the type of the arrival time may also be displayed.

For example, as shown in FIG. 15, in the case where the point Lp for calculating the arrival time is on the bow line HD of the own ship SH (see FIG. 13), a string MT indicating that the arrival time is a BCT is displayed on the risk area OZ.

In addition, as shown in FIG. 16, in the case where the point Lp for calculating the arrival time is at the position at which the own ship SH and the other ship OP are closest to each other, a string MT indicating that the arrival time is a TCPA is displayed on the risk area OZ.

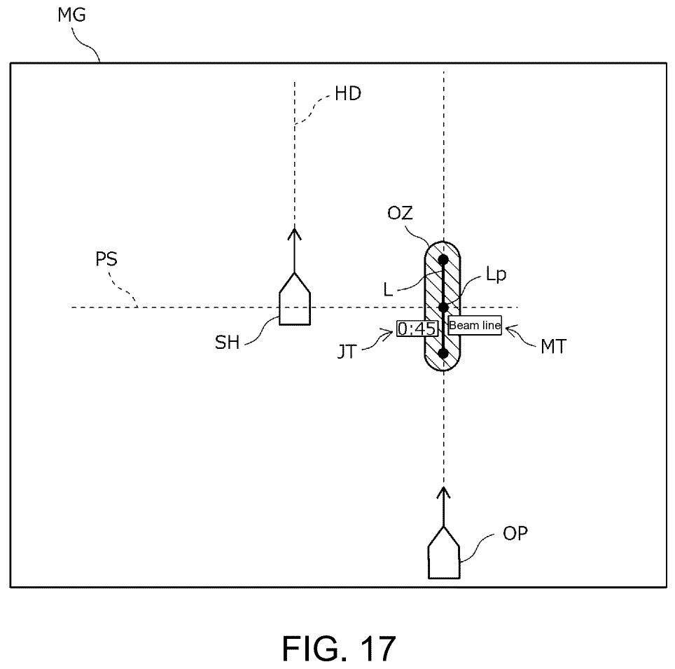

In addition, as shown in FIG. 17, in the case where the point Lp for calculating the arrival time is on the beam line PS of the own ship SH (see FIG. 14), a string MT indicating that the arrival time is a time to a point passing through the beam line is displayed on the risk area OZ.

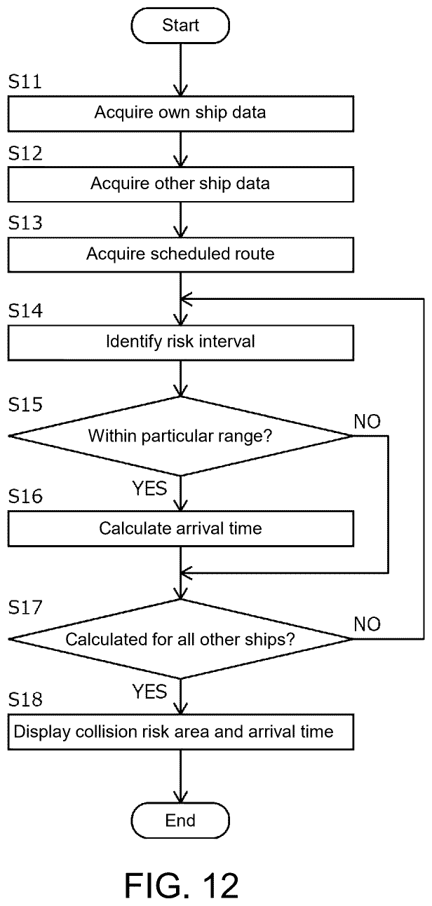

FIG. 12 is a view showing a procedure example of a navigation assistance method realized in the navigation assistance device 1. The processing circuitry 20 of the navigation assistance device 1 executes the information processing shown in the figure according to a program.

First, the processing circuitry 20 acquires own ship data representing the position and the speed of the own ship SH from the GNSS receiver 6 (S11, processing as the own ship data acquiring unit 11).

Next, the processing circuitry 20 acquires other ship data representing the position and the speed of an other ship OP from the radar 3, the AIS 4, or the camera 5 (S12, processing as the other ship data acquiring unit 12).

Next, the processing circuitry 20 acquires a scheduled route SR of the own ship SH from the ECDIS 8 (S13, processing as the route acquiring unit 13).

Next, the processing circuitry 20 identifies a risk interval L where a risk of the own ship SH and the other ship OP approaching each other is equal to or greater than a particular value for displaying a risk area OZ (S14, processing as the risk area identifying unit 14, see FIG. 4).

Next, the processing circuitry 20 determines whether the identified risk interval L is included in a particular range DA defined based on the own ship SH (S15, processing as the display determining unit 15, see FIG. 5 to FIG. 7).

In the case where the risk interval L is included in the particular range DA (S15: YES), the processing circuitry 20 calculates an arrival time until the own ship SH arrives at the risk interval L (S16, processing as the arrival time calculating unit 16, see FIG. 5 to FIG. 7).

On the other hand, in the case where the risk interval L is not included in the particular range DA (S15: NO), the processing circuitry 20 does not calculate an arrival time.

The processing circuitry 20 performs calculation of the processing of S14 to S16 above for all other ships OP (S17).

Next, the processing circuitry 20 displays an image MG including a risk area OZ1 and a string JT representing the arrival time on the display unit 2 (S18, processing as the display control unit 17, see FIG. 9 and FIG. 10).

Although the embodiments of the disclosure have been described above, the disclosure is not limited to the embodiments described above, and obviously various modifications are possible for those skilled in the art.

Representative embodiments of the disclosure are listed below.

(1)

A navigation assistance device including:
a first acquiring unit configured to acquire first ship data including a position and a speed of a first ship;
a second acquiring unit configured to acquire second ship data including a position and a speed of a second ship;
an identifying unit configured to identify a risk area where a risk of the first ship and the second ship approaching each other is equal to or greater than a particular value;
a calculating unit configured to calculate an arrival time until the first ship arrives at the risk area; and
a display unit configured to display the risk area and display the arrival time in association with the risk area.
   (2)

The navigation assistance device according to (1), where
the calculating unit is further configured to calculate the arrival time to a point in the risk area that is closest to the first ship.
   (3)

The navigation assistance device according to (1), where
the calculating unit is further configured to calculate the arrival time to a point in the risk area that is located on a bow direction of the first ship.
   (4)

The navigation assistance device according to any one of (1) to (3), further including:
a determining unit configured to determine an encountering relationship between the first ship and the second ship, where
the calculating unit is further configured to determine a point for calculating the arrival time in the risk area according to the encountering relationship.
   (5)

The navigation assistance device according to any one of (1) to (4), where
the display unit is further configured to display a type of the arrival time in the risk area.
   (6)

The navigation assistance device according to any one of (1) to (5), further including:
a determining unit configured to determine whether the risk area is included in a particular range defined based on the first ship, where
the calculating unit is further configured to calculate the arrival time to the risk area included in the particular range.
   (7)

The navigation assistance device according to (6), where
the particular range is a range where a distance from the first ship or the arrival time of the first ship is equal to or less than a particular value.
   (8)

The navigation assistance device according to (6) or (7), where
the particular range is a particular angle range including a bow direction of the first ship.
   (9)

The navigation assistance device according to any one of (6) to (8), where
the calculating unit is further configured to calculate the arrival time to a portion of the risk area that is included in the particular range.
   (10)

The navigation assistance device according to any one of (1) to (9), further including:
a route acquiring unit configured to acquire a scheduled route of the first ship, where
the calculating unit is further configured to calculate the arrival time for the first ship to navigate the scheduled route and arrive at the risk area.
   (11)

The navigation assistance device according to (10), where
the calculating unit is further configured to calculate the arrival time to a point in the risk area that is located on the scheduled route.
   (12)

The navigation assistance device according to any one of (1) to (11), where
the identifying unit is further configured to identify, as the risk area, an interval of a predicted route of the second ship where a risk of the first ship and the second ship approaching each other is equal to or greater than a particular value, with the first ship changing course and navigating in any direction to cross the predicted route of the second ship.
   (13)

A navigation assistance method including:
acquiring first ship data including a position and a speed of a first ship;
acquiring second ship data including a position and a speed of a second ship;
identifying a risk area where a risk of the first ship and the second ship approaching each other is equal to or greater than a particular value;
calculating an arrival time until the first ship arrives at the risk area; and
displaying the risk area and displaying the arrival time in association with the risk area.
   (14)

A program for causing a computer to execute processing configured to:
acquire first ship data including a position and a speed of a first ship;
acquire second ship data including a position and a speed of a second ship;
identify a risk area where a risk of the first ship and the second ship approaching each other is equal to or greater than a particular value;
calculate an arrival time until the first ship arrives at the risk area; and
display the risk area and display the arrival time in association with the risk area.

### Terminology

It is to be understood that not necessarily all objects or advantages may be achieved in accordance with any particular embodiment described herein. Thus, for example, those skilled in the art will recognize that certain embodiments may be configured to operate in a manner that achieves or optimizes one advantage or group of advantages as taught herein without necessarily achieving other objects or advantages as may be taught or suggested herein.

All of the processes described herein may be embodied in, and fully automated via, software code modules executed by a computing system that includes one or more computers or processors. The code modules may be stored in any type of non-transitory computer-readable medium or other computer storage device. Some or all the methods may be embodied in specialized computer hardware.

Many other variations than those described herein will be apparent from this disclosure. For example, depending on the embodiment, certain acts, events, or functions of any of the algorithms described herein can be performed in a different sequence, can be added, merged, or left out altogether (e.g., not all described acts or events are necessary for the practice of the algorithms). Moreover, in certain embodiments, acts or events can be performed concurrently, e.g., through multi-threaded processing, interrupt processing, or multiple processors or processor cores or on other parallel architectures, rather than sequentially. In addition, different tasks or processes can be performed by different machines and/or computing systems that can function together.

The various illustrative logical blocks and modules described in connection with the embodiments disclosed herein can be implemented or performed by a machine, such as a processor. A processor can be a microprocessor, but in the alternative, the processor can be a controller, microcontroller, or state machine, combinations of the same, or the like. A processor can include electrical circuitry configured to process computer-executable instructions. In another embodiment, a processor includes an application specific integrated circuit (ASIC), a field programmable gate array (FPGA) or other programmable device that performs logic operations without processing computer-executable instructions. A processor can also be implemented as a combination of computing devices, e.g., a combination of a digital signal processor (DSP) and a microprocessor, a plurality of microprocessors, one or more microprocessors in conjunction with a DSP core, or any other such configuration. Although described herein primarily with respect to digital technology, a processor may also include primarily analog components. For example, some or all of the signal processing algorithms described herein may be implemented in analog circuitry or mixed analog and digital circuitry. A computing environment can include any type of computer system, including, but not limited to, a computer system based on a microprocessor, a mainframe computer, a digital signal processor, a portable computing device, a device controller, or a computational engine within an appliance, to name a few.

Conditional language such as, among others, “can,” “could,” “might” or “may,” unless specifically stated otherwise, are otherwise understood within the context as used in general to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Any process descriptions, elements or blocks in the flow diagrams described herein and/or depicted in the attached figures should be understood as potentially representing modules, segments, or portions of code which include one or more executable instructions for implementing specific logical functions or elements in the process. Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations. For example, “a processor configured to carry out recitations A, B and C” can include a first processor configured to carry out recitation A working in conjunction with a second processor configured to carry out recitations B and C. The same holds true for the use of definite articles used to introduce embodiment recitations. In addition, even if a specific number of an introduced embodiment recitation is explicitly recited, those skilled in the art will recognize that such recitation should typically be interpreted to mean at least the recited number (e.g., the bare recitation of “two recitations,” without other modifiers, typically means at least two recitations, or two or more recitations).

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.).

For expository purposes, the term “horizontal” as used herein is defined as a plane parallel to the plane or surface of the floor of the area in which the system being described is used or the method being described is performed, regardless of its orientation. The term “floor” can be interchanged with the term “ground” or “water surface”. The term “vertical” refers to a direction perpendicular to the horizontal as just defined. Terms such as “above,” “below,” “bottom,” “top,” “side,” “higher,” “lower,” “upper,” “over,” and “under,” are defined with respect to the horizontal plane.

As used herein, the terms “attached,” “connected,” “mated,” and other such relational terms should be construed, unless otherwise noted, to include removable, moveable, fixed, adjustable, and/or releasable connections or attachments. The connections/attachments can include direct connections and/or connections having intermediate structure between the two components discussed.

Numbers preceded by a term such as “approximately”, “about”, and “substantially” as used herein include the recited numbers, and also represent an amount close to the stated amount that still performs a desired function or achieves a desired result. For example, the terms “approximately”, “about”, and “substantially” may refer to an amount that is within less than 10% of the stated amount. Features of embodiments disclosed herein preceded by a term such as “approximately”, “about”, and “substantially” as used herein represent the feature with some variability that still performs a desired function or achieves a desired result for that feature.

It should be emphasized that many variations and modifications may be made to the above-described embodiments, the elements of which are to be understood as being among other acceptable examples. All such modifications and variations are intended to be included herein within the scope of this disclosure and protected by the following claims.

### REFERENCE SIGNS LIST

1 navigation assistance device, 2 display unit, 3 radar, 4 AIS, 5 camera, 6 GNSS receiver, 7 gyrocompass, 8 ECDIS, 9 wireless communicating unit, 10 ship operation control unit, 20 processing circuitry, 11 own ship data acquiring unit (example of first acquiring unit), 12 other ship data acquiring unit (example of second acquiring unit), 13 route acquiring unit, 14 risk area identifying unit, 15 display determining unit, 16 arrival time calculating unit, 17 display control unit, 18 encountering relationship determining unit, 100 onboard system

1. A navigation assistance device comprising:
processing circuitry configured to:
acquire first ship data comprising a position and a speed of a first ship;
acquire second ship data comprising a position and a speed of a second ship;
identify a risk area where a risk of the first ship and the second ship approaching each other is equal to or greater than a particular value;
calculate an arrival time until the first ship arrives at the risk area; and
display the risk area and display the arrival time in association with the risk area.

2. The navigation assistance device according to claim 1, wherein
the processing circuitry is further configured to calculate the arrival time to a point in the risk area that is closest to the first ship.

3. The navigation assistance device according to claim 1, wherein
the processing circuitry is further configured to calculate the arrival time to a point in the risk area that is located on a bow direction of the first ship.

4. The navigation assistance device according to claim 1, wherein
the processing circuitry is further configured to:
determine an encountering relationship between the first ship and the second ship, and
determine a point for calculating the arrival time in the risk area according to the encountering relationship.

5. The navigation assistance device according to claim 2, wherein
the processing circuitry is further configured to:
determine an encountering relationship between the first ship and the second ship, and
determine a point for calculating the arrival time in the risk area according to the encountering relationship.

6. The navigation assistance device according to claim 3, wherein
the processing circuitry is further configured to:
determine an encountering relationship between the first ship and the second ship, and
determine a point for calculating the arrival time in the risk area according to the encountering relationship.

7. The navigation assistance device according to claim 1, wherein
the processing circuitry is further configured to display a type of the arrival time in the risk area.

8. The navigation assistance device according to claim 4, wherein
the processing circuitry is further configured to display a type of the arrival time in the risk area.

9. The navigation assistance device according to claim 1, wherein
the processing circuitry is further configured to:
determine whether the risk area is included in a particular range defined based on the first ship, and
calculate the arrival time to the risk area included in the particular range.

10. The navigation assistance device according to claim 4, wherein
the processing circuitry is further configured to:
determine whether the risk area is included in a particular range defined based on the first ship, and
calculate the arrival time to the risk area included in the particular range.

11. The navigation assistance device according to claim 7, wherein
the processing circuitry is further configured to:
determine whether the risk area is included in a particular range defined based on the first ship, and
calculate the arrival time to the risk area included in the particular range.

12. The navigation assistance device according to claim 9, wherein
the particular range is a range where a distance from the first ship or the arrival time of the first ship is equal to or less than a particular value.

13. The navigation assistance device according to claim 9, wherein
the particular range is a particular angle range including a bow direction of the first ship.

14. The navigation assistance device according to claim 9, wherein
the processing circuitry is further configured to calculate the arrival time to a portion of the risk area that is included in the particular range.

15. The navigation assistance device according to claim 1, wherein
the processing circuitry is further configured to:
acquire a scheduled route of the first ship, and
calculate the arrival time for the first ship to navigate the scheduled route and arrive at the risk area.

16. The navigation assistance device according to claim 15, wherein
the processing circuitry is further configured to calculate the arrival time to a point in the risk area that is located on the scheduled route.

17. The navigation assistance device according to claim 1, wherein
the processing circuitry is further configured to identify, as the risk area, an interval of a predicted route of the second ship where a risk of the first ship and the second ship approaching each other is equal to or greater than a particular value, with the first ship changing course and navigating in any direction to cross the predicted route of the second ship.

18. A navigation assistance method comprising:
acquiring first ship data comprising a position and a speed of a first ship;
acquiring second ship data comprising a position and a speed of a second ship;
identifying a risk area where a risk of the first ship and the second ship approaching each other is equal to or greater than a particular value;
calculating an arrival time until the first ship arrives at the risk area; and
displaying the risk area and displaying the arrival time in association with the risk area.

19. A non-transitory computer-readable recording medium recording a program for causing a computer to execute processing configured to:
acquire first ship data comprising a position and a speed of a first ship;
acquire second ship data comprising a position and a speed of a second ship;
identify a risk area where a risk of the first ship and the second ship approaching each other is equal to or greater than a particular value;
calculate an arrival time until the first ship arrives at the risk area; and
display the risk area and display the arrival time in association with the risk area.
